(19) United States
(12) Patent Application Publication
(10) Pub. No.: US 2026/0267412 A1
(43) Pub. Date: Sep. 10, 2026

(54) HAPTIC FEEDBACK MODULE AND HAPTIC FEEDBACK APPARATUS

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Yongchun Tao, Beijing (CN); Dexing Qi, Beijing (CN); Yingzi Wang, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/994,906

(22) PCT Filed: Apr. 18, 2024
(86) PCT No.: PCT/CN2024/088650

§ 371 Date: Jan. 15, 2025

(30) Foreign Application Priority Data
May 6, 2023 (CN) 202310505168.7

(51) Int. Cl. G06F 3/01; G06F 3/041

(52) U.S. Cl. CPC G06F 3/016; G06F 3/04142; G06F 3/04164

(57) ABSTRACT

A haptic feedback module and a haptic feedback apparatus relate to the technical field of electronics. The haptic feedback module includes: a touch control module having a touch control face; at least one pressure-sensitive detector disposed on one side of the touch control module facing away from the touch control face, and used for detecting pressure information of a touch control body on the touch control face; and at least one actuator disposed on at least one side of the touch control module, and used for driving the touch control module to generate vibration in response to a driving signal, so as to form haptic feedback on the touch control face.

### CROSS-REFERENCE TO RELATED APPLICATION

This application claims the priority of the Chinese patent application filed on May 6, 2023 before the CNIPA, China National Intellectual Property Administration with the application number of 202310505168.7 and the title of “HAPTIC FEEDBACK MODULE AND HAPTIC FEEDBACK APPARATUS”, which is incorporated herein in its entirety by reference.

### TECHNICAL FIELD

The present disclosure relates to the technical field of electronics, and more particularly relates to a haptic feedback module and a haptic feedback apparatus.

### BACKGROUND

Haptic feedback is a frontier technology in the field of virtual reality and human-computer interaction, and multimedia terminals such as smartphones and tablet computers applying the haptic feedback technology have broad application prospects in the fields of education, entertainment, medical treatment, and the like. With the vigorous development of new energy automobiles, vehicle-mounted large display screens have become a trend, and more and more interactive components such as physical keys and knobs have been implemented on touch display screens.

### SUMMARY

The present disclosure provides a haptic feedback module, including:
a touch control module having a touch control face;
at least one pressure-sensitive detector disposed on one side of the touch control module facing away from the touch control face, and used for detecting pressure information of a touch control body on the touch control face; and
at least one actuator disposed on at least one side of the touch control module, and used for driving the touch control module to generate vibration in response to a driving signal, so as to form haptic feedback on the touch control face.

In some embodiments, the at least one pressure-sensitive detector comprises at least one of:
a first pressure-sensitive detector, wherein an orthographic projection of the first pressure-sensitive detector on the touch control face is disposed close to a geometric center of the touch control face;
a second pressure-sensitive detector, wherein an orthographic projection of the second pressure-sensitive detector on the touch control face is disposed close to an edge of the touch control face; and
a third pressure-sensitive detector, wherein a shape of the touch control face is a polygonal shape, and an orthographic projection of the third pressure-sensitive detector on the touch control face is disposed close to an interior angle of the polygonal shape.

In some embodiments, comprising a plurality of pressure-sensitive detectors, wherein the plurality of pressure-sensitive detectors comprise a first detector group and a second detector group, and an orthographic projection of the first detector group on the touch control face and an orthographic projection of the second detector group on the touch control face are respectively disposed close to opposite edges of the touch control face.

In some embodiments, comprising a plurality of pressure-sensitive detectors, wherein an orthographic projection of the plurality of pressure-sensitive detectors on the touch control face are symmetrically disposed with respect to a geometric center of the touch control face.

In some embodiments, further comprising:
a module outer bezel comprising a bottom plate, wherein the bottom plate is located on one side of the touch control module facing away from the touch control face.

In some embodiments, the pressure-sensitive detector is located on one side of the touch control module close to the bottom plate.

In some embodiments, the pressure-sensitive detector comprises a first surface and a second surface which are disposed opposite to each other, the first surface is connected to the touch control module, the second surface is located on one side of the first surface away from the touch control module, and the haptic feedback module further comprises:
at least one cantilever beam comprising a first cantilever beam, wherein one end of the first cantilever beam is connected to the second surface and the other end of the first cantilever beam is connected to the bottom plate.

In some embodiments, the at least one cantilever beam further comprises:
a second cantilever beam, wherein one end of the second cantilever beam is connected to the touch control module and the other end of the second cantilever beam is connected to the bottom plate; and
wherein in a normal direction of the touch control face, a height of the second cantilever beam is greater than a height of the first cantilever beam.

In some embodiments, a shape of a longitudinal cross section of the cantilever beam comprises at least one of: an H shape, a Z shape, a three-sided box shape, an I shape, an L shape, a T shape, and a rectangular shape, and the longitudinal cross section of the cantilever beam is perpendicular to the touch control face.

In some embodiments, the first cantilever beam comprises: a first cantilever, a first connecting face, and a second connecting face; the first cantilever is located between the first connecting face and the second connecting face, the first connecting face and the second surface are parallel to each other and are connected to each other, the second connecting face and the bottom plate are parallel to each other and are connected to each other, and an extension direction of the first cantilever and a plane where the bottom plate is located intersect with each other.

In some embodiments, in a first direction, a width of the first cantilever is less than a width of the first connecting face and the second connecting face, and the first direction is a direction parallel to the touch control face.

In some embodiments, a shape of an orthographic projection of the pressure-sensitive detector on the touch control face comprises at least one of: a circular shape, an elliptical shape, a polygonal shape, a fan shape, an annular shape, and an irregular pattern.

In some embodiments, the actuator is located between the touch control module and the bottom plate.

In some embodiments, the actuator comprises a third surface and a fourth surface which are disposed opposite to each other along the first direction, and the first direction is parallel to the touch control face; and the haptic feedback module further comprises:
a first supporting portion connected between the third surface and the touch control module; and
a second supporting portion connected between the fourth surface and the bottom plate.

In some embodiments, the first supporting portion is in rigid connection with the third surface, and the first supporting portion is in rigid connection with the touch control module; and
the second supporting portion is in flexible or rigid connection with the bottom plate.

In some embodiments, the first supporting portion comprises a first supporting face and a second supporting face which are cross-connected to each other, the first supporting face is parallel to the touch control face, the second supporting face is located on one side of the first supporting face away from the touch control module, the first supporting face is connected to the touch control module, and the second supporting face is connected to the third surface.

In some embodiments, the second supporting portion comprises a third supporting face and a fourth supporting face which are cross-connected to each other, the third supporting face is parallel to the bottom plate, the fourth supporting face is located on one side of the third supporting face away from the bottom plate, the third supporting face is connected to the bottom plate, and the fourth supporting face is connected to the fourth surface.

In some embodiments, the entire third surface is connected to the second supporting face.

In some embodiments, in a normal direction of the touch control face, a size of the second supporting face is greater than a size of the actuator, and a size of the fourth supporting face is greater than the size of the actuator.

In some embodiments, in the normal direction of the touch control face, the actuator is connected to a part of the second supporting face away from the touch control module, and the actuator is connected to a part of the fourth supporting face close to the touch control module.

In some embodiments, in the first direction, the actuator is connected to a middle area of the first supporting portion, the actuator is connected to a middle area of the second supporting portion, and an edge area of the first supporting portion is connected to an edge area of the second supporting portion through a rigid connector.

In some embodiments, a shape of a longitudinal cross section of the first supporting portion comprises at least one of: an H shape, a Z shape, a three-sided box shape, an I shape, an L shape, a T shape, and a rectangular shape, and the longitudinal cross section of the first supporting portion is perpendicular to the touch control face; and/or
a shape of a longitudinal cross section of the second supporting portion comprises at least one of: the H shape, the Z shape, the three-sided box shape, the I shape, the L shape, the T shape, and the rectangular shape, and the longitudinal cross section of the second supporting portion is perpendicular to the touch control face.

In some embodiments, the actuator comprises a fifth surface and a sixth surface which are disposed opposite to each other along a second direction, the second direction is perpendicular to the touch control face, the fifth surface is connected to the touch control module, and the haptic feedback module further comprises:
a third supporting portion connected between the sixth surface and the bottom plate.

In some embodiments, the fifth surface is in rigid connection with the touch control module, and the third supporting portion is in flexible or rigid connection with the bottom plate.

In some embodiments, the actuator and the pressure-sensitive detector are located on a same side of the touch control module.

In some embodiments, an orthographic projection of the actuator on the touch control face is disposed close to a geometric center of the touch control face; and/or
the orthographic projection of the actuator on the touch control face is disposed close to an edge of the touch control face; and/or
the touch control face is in a polygonal shape, and the orthographic projection of the actuator on the touch control face is disposed close to an interior angle of the polygonal shape.

In some embodiments, the pressure-sensitive detector comprises at least one of: a lead zirconate titanate (PZT) piezoelectric thin film, monolithic piezoelectric ceramic, stacked piezoelectric ceramic, cymbal-shaped piezoelectric ceramic, a monolithic polyvinylidene fluoride film, a stacked polyvinylidene fluoride film, and a cymbal-shaped polyvinylidene fluoride film.

In some embodiments, the actuator comprises at least one of: a lead zirconate titanate (PZT) piezoelectric thin film, monolithic piezoelectric ceramic, stacked piezoelectric ceramic, cymbal-shaped piezoelectric ceramic, a monolithic polyvinylidene fluoride film, a stacked polyvinylidene fluoride film, and a cymbal-shaped polyvinylidene fluoride film.

The present disclosure provides a haptic feedback apparatus, comprising:
the haptic feedback module according to any one of the embodiments, wherein the touch control module comprises at least one of: a touch control circuit, a display panel, and a backlight module; and
a driving component respectively connected to the touch control module, the pressure-sensitive detector, and the actuator, and used for driving the display panel to display an image, and outputting a driving signal to the actuator according to touch control information of a touch control body on the touch control module, and pressure information of the touch control body on the touch control module detected by the pressure-sensitive detector, so that the actuator drives the touch control module to vibrate in response to the driving signal, so as to form the haptic feedback on the touch control face, wherein the touch control information comprises at least one of: a touch control position, a touch control time, and a touch control action.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and understandable, the specific embodiments of the present disclosure are listed below.

### BRIEF DESCRIPTION OF THE DRAWINGS

In order to provide a clearer explanation of the technical solutions in the embodiments of the present disclosure or in the related art, a brief introduction will be given to the accompanying drawings required for the description of the embodiments or related art. It is obvious that the accompanying drawings in the following description are some embodiments of the present disclosure. For those skilled in the art, other drawings can be obtained based on these drawings without creative work. It should be noted that the scale in the accompanying drawings is only for illustration and does not represent the actual scale.

FIG. 1 illustratively shows a schematic diagram of a planar structure of a first type of haptic feedback module;

FIG. 2 illustratively shows a schematic diagram of cross-sectional structures of a plurality of types of haptic feedback modules along AA′;

FIG. 3 illustratively shows a schematic diagram of a planar structure of a second type of haptic feedback module;

FIG. 4 illustratively shows a schematic diagram of a planar structure of a third type of haptic feedback module;

FIG. 5 illustratively shows a schematic diagram of a planar structure of a fourth type of haptic feedback module;

FIG. 6 illustratively shows a schematic diagram of a planar structure of a fifth type of haptic feedback module;

FIG. 7 illustratively shows a schematic diagram of a planar structure of a sixth type of haptic feedback module;

FIG. 8 illustratively shows a schematic diagram of a planar structure of a seventh type of haptic feedback module;

FIG. 9 illustratively shows a schematic diagram of a planar structure of an eighth type of haptic feedback module;

FIG. 10 illustratively shows a schematic diagram of a planar structure of a ninth type of haptic feedback module;

FIG. 11 illustratively shows a schematic diagram of a cross-sectional structure of the eighth type of haptic feedback module along BB′;

FIG. 12 illustratively shows a schematic planar diagram of a pressure-sensitive detector and a touch control position on a touch control face;

FIG. 13 illustratively shows an exemplary diagram of a haptic feedback module and pressure information test results thereof;

FIG. 14 illustratively shows an exemplary diagram of another haptic feedback module and pressure information test results thereof;

FIG. 15 illustratively shows a schematic diagram of a cross-sectional structure of cymbal-shaped piezoelectric ceramic; and

FIG. 16 illustratively shows a schematic diagram of a connecting structure of a haptic feedback apparatus.

### DETAILED DESCRIPTION OF THE EMBODIMENTS

In order to clarify the purpose, technical solution, and advantages of the embodiments of the present disclosure, a clear and complete description of the technical solution in the embodiments of the present disclosure will be provided below in conjunction with the accompanying drawings. Obviously, the described embodiments are a part of the embodiments of the present disclosure, not all of the embodiments. Based on the embodiments of the present disclosure, all other embodiments obtained by persons skilled in the art without creative work are within the scope of protection of the present disclosure.

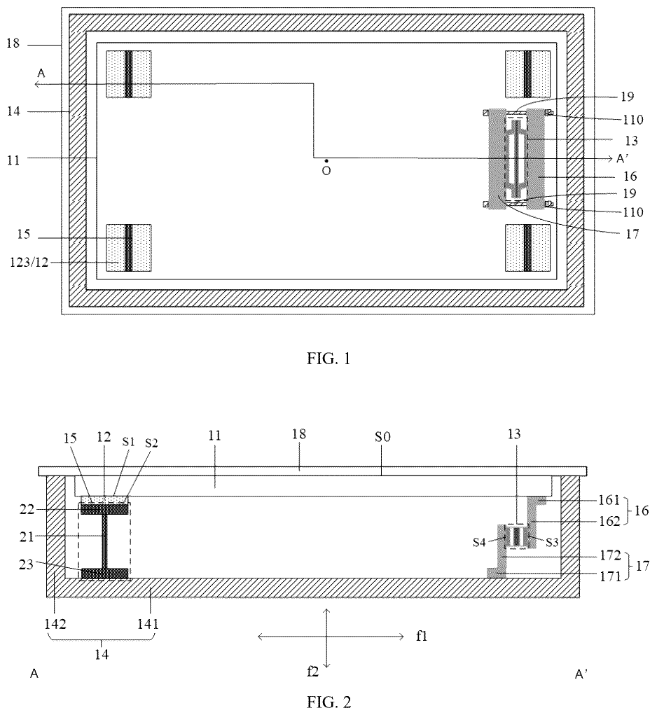

The present disclosure provides a haptic feedback module. As shown in any one of FIG. 1 to FIG. 10, the haptic feedback module includes: a touch control module 11 having a touch control face S0; at least one pressure-sensitive detector 12 disposed on one side of the touch control module 11 facing away from the touch control face S0, and used for detecting pressure information of a touch control body on the touch control face S0; and at least one actuator 13 disposed on at least one side of the touch control module 11, and used for driving the touch control module 11 to generate vibration in response to a driving signal, so as to form haptic feedback on the touch control face S0.

Illustratively, the touch control module 11 may include one or more of a touch control circuit, a display panel, a backlight module, and the like, which is not limited in the present disclosure.

Illustratively, the touch control body may be an object such as a finger or a stylus, which is not limited in the present disclosure.

When the touch control body applies touch control operation on the touch control face S0, the pressure-sensitive detector 12 may detect pressure information of the touch control body on the touch control module 11, and the pressure information may, for example, include touch control pressure, or include a parameter capable of representing the magnitude of the touch control pressure, such as a deformation amount generated by the touch control module 11 under the touch control operation of the touch control body, may also include a pressure position (namely, a touch control position), and may also include information such as the movement of the pressure position (namely, a touch control action). In this way, multi-azimuth detection of human-computer interaction information such as an interaction position, action, and strength may be achieved, and then a haptic feedback effect corresponding to a scene may be provided according to the detected human-computer interaction information.

Illustratively, a driving signal may be generated according to the touch control information of the touch control body on the touch control module 11 and the pressure information detected by the pressure-sensitive detector 12, and output to the actuator 13, and the actuator 13 drives the touch control module 11 to vibrate in response to the driving signal, so as to form the haptic feedback on the touch control face S0, wherein the touch control information includes at least one of: a touch control position, a touch control time, and a touch control action.

The haptic feedback module provided in the present disclosure may be applied on a vehicle-mounted touchscreen display screen for performing human-computer interaction, and provide real-time haptic feedback for a user based on the touch control information and the pressure information, thereby being of important significance and value for improving driving safety and interaction effectiveness, enriching interaction experience, and the like.

In some embodiments, the pressure-sensitive detector 12 includes at least one of: a lead zirconate titanate (PZT) piezoelectric thin film, monolithic piezoelectric ceramic, stacked piezoelectric ceramic (as shown in FIG. 2), cymbal-shaped piezoelectric ceramic, a monolithic polyvinylidene fluoride film, a stacked polyvinylidene fluoride film, and a cymbal-shaped polyvinylidene fluoride film. During specific implementation, the pressure-sensitive detector 12 may also be other sensors capable of converting strain into an electrical signal, such as a strain-type sensor, which is not limited in the present disclosure.

Illustratively, the pressure-sensitive detector 12 is a device operating by utilizing a positive piezoelectric effect of a piezoelectric material, which is used for sensing displacement deformation generated by touch control of the touch control body on the touch control module 11 and generating an electrical signal. The phenomenon that polarization of the piezoelectric material under the action of pressure causes a potential difference between surfaces at two ends is called the “positive piezoelectric effect”. Compared with a monolithic structure, the pressure-sensitive detectors 12 of a stacked structure and a cymbal-shaped structure have higher sensitivity, and can generate an electrical signal for small displacement.

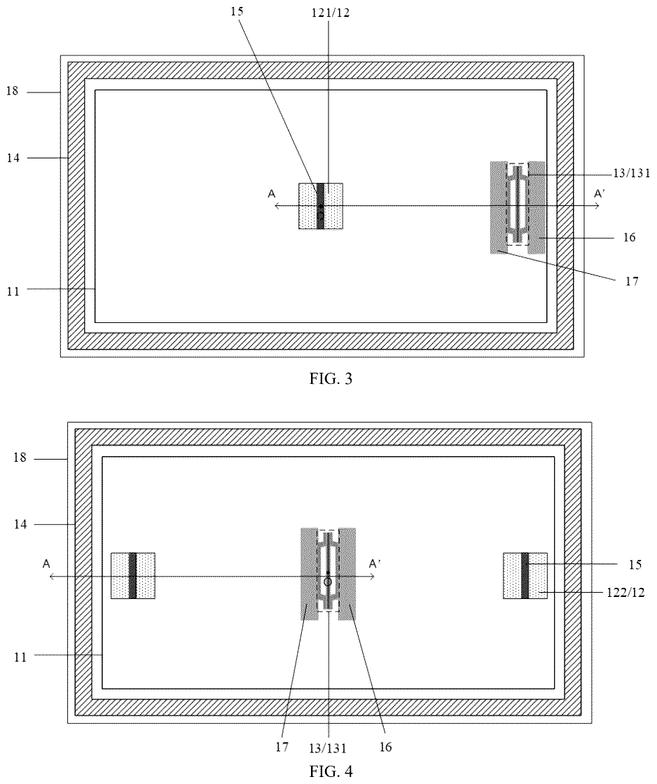

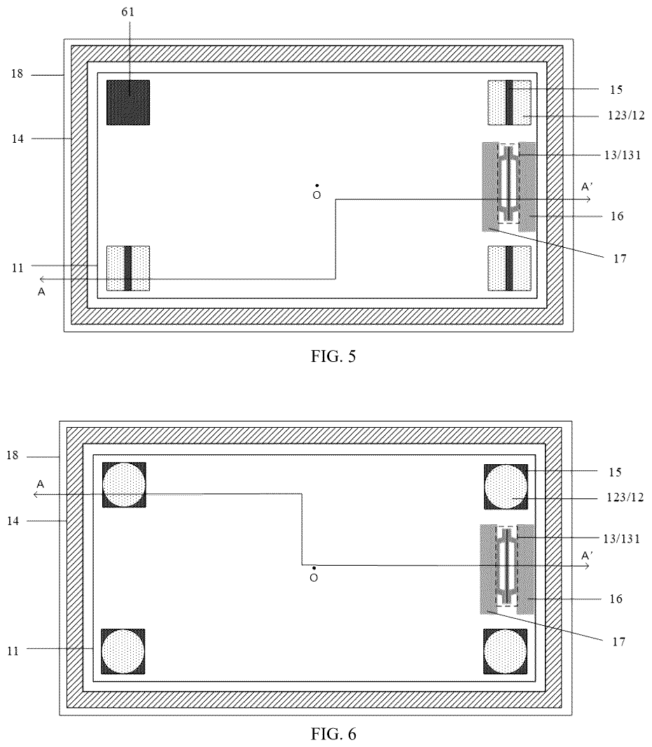

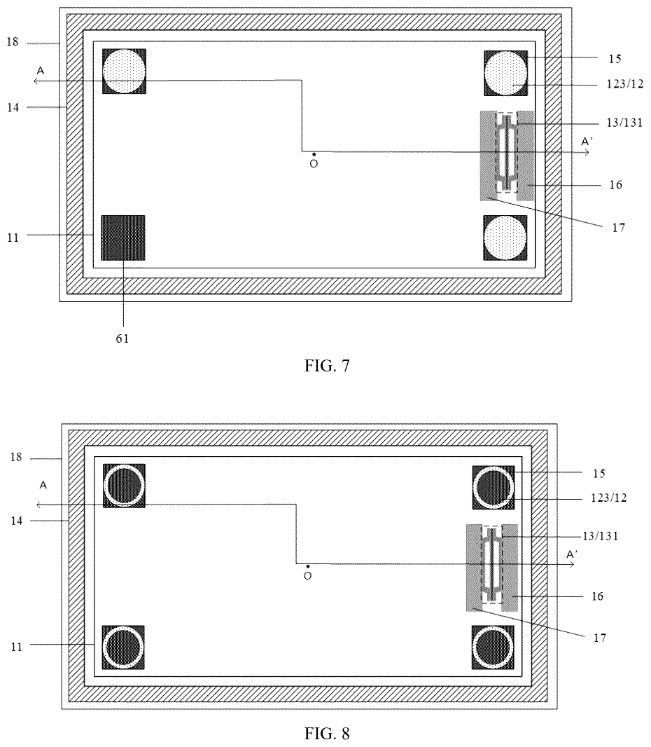

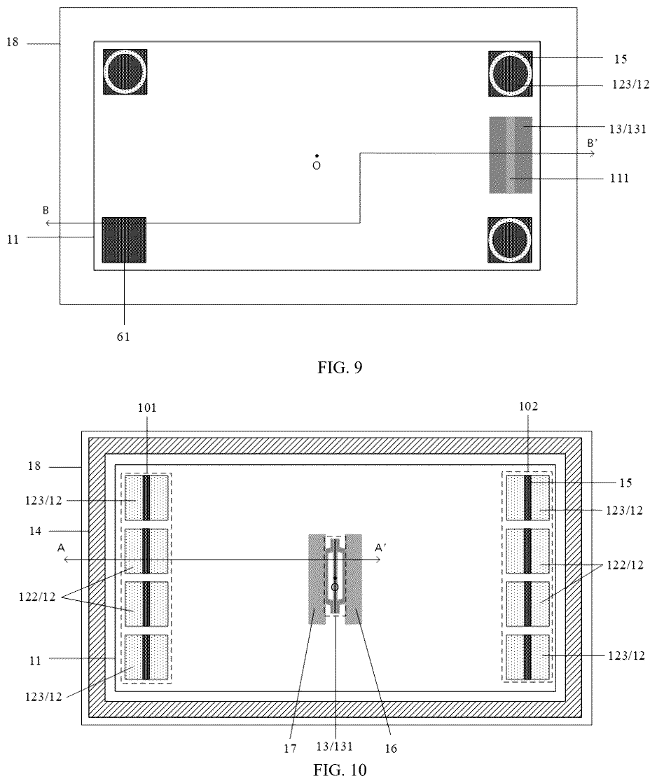

Illustratively, the haptic feedback module may include one or more pressure-sensitive detectors 12. As shown in FIG. 3, the haptic feedback module includes one pressure-sensitive detector 12; as shown in FIG. 4, the haptic feedback module includes two pressure-sensitive detectors 12; as shown in FIG. 5, FIG. 7 and FIG. 9, the haptic feedback module includes three pressure-sensitive detectors 12; as shown in FIG. 1, FIG. 6 and FIG. 8, the haptic feedback module includes four pressure-sensitive detectors 12; and as shown in FIG. 10, the haptic feedback module includes eight pressure-sensitive detectors 12.

Referring to FIG. 12, a schematic planar diagram of the pressure-sensitive detector 12 and the touch control position on the touch control module 11 is shown. As shown in FIG. 12, four pressure-sensitive detectors 12 are disposed in the haptic feedback module, which are respectively marked as 1 #, 2 #, 3 #, and 4 #, and positions are respectively (a, b), (−a, b), (−a, −b), and (a, −b). When the finger presses at a touch control position (x, y), force signal values output by the four pressure-sensitive detectors 12 are sequentially as follows: F1, F2, F3, and F4. According to force balance and torque balance, the following formulas may be obtained:

$$F + {F}_{1} + {F}_{2} + {F}_{3} + {F}_{4} = 0$$

$${F}_{1} ( a - x ) + {F}_{4} ( a - x ) = {F}_{2} ( x + a ) + {F}_{3} ( x + a )$$

$${F}_{1} ( b - y ) + {F}_{2} ( b - y ) = {F}_{3} ( y + b ) + {F}_{4} ( y + b ) .$$

The touch control pressure F and the touch control position (x, y) may be obtained by solving the above formulas. In the case where the haptic feedback module is provided with a plurality of pressure-sensing detectors 12, according to a detection result, not only the touch control pressure or the parameter capable of representing the magnitude of the touch control pressure can be obtained, but also information such as the touch control position can be obtained. In this case, the touch control position and relevant information thereof do not need to be obtained through the touch control module 11, and then a touch control circuit does not need to be disposed in the touch control module 11, thereby simplifying the structure of the touch control module 11.

In the case where only one pressure-sensitive detector 12 is disposed in the haptic feedback module (as shown in FIG. 3), according to the detection result, the touch control pressure or the parameter capable of representing the magnitude of the touch control pressure may be obtained, and the touch control position and relevant parameters thereof cannot be obtained. In this case, the touch control position and the relevant parameters thereof may be detected by the touch control module 11.

Among them, values of a and b in position coordinates of the four pressure-sensitive detectors 12 are related to a size of the touch control module 11. For example, with regard to a 15.6-inch touch control module 11, by taking a geometric center O of the touch control module 11 as an origin point, a value range of the value of a may be between +86 mm and +172 mm, for example, may be 152 mm; and a value range of the value of b may be between +48 mm and +96 mm, for example, may be 86 mm.

In some embodiments, as shown in FIG. 3, the above at least one pressure-sensitive detector 12 includes a first pressure-sensitive detector 121, and an orthographic projection of the first pressure-sensitive detector 121 on the touch control face S0 is disposed close to a geometric center O of the touch control face S0.

During specific implementation, the haptic feedback module may include one or more first pressure-sensitive detectors 121. In FIG. 3, the haptic feedback module includes one pressure-sensitive detector 12, namely, a first pressure-sensitive detector 121. By disposing the one or more pressure-sensitive detectors 12 at positions close to the geometric center O of the touch control face S0, the accuracy of pressure detection can be improved, and a calculation process of the pressure information can be simplified.

In some embodiments, as shown in FIG. 4, the above at least one pressure-sensitive detector 12 includes a second pressure-sensitive detector 122, and an orthographic projection of the second pressure-sensitive detector 122 on the touch control face S0 is disposed close to an edge of the touch control face S0.

During specific implementation, the haptic feedback module may include one or more second pressure-sensitive detectors 122. By disposing a plurality of second pressure-sensitive detectors 122 in the haptic feedback module, and disposing the plurality of second pressure-sensitive detectors 122 close to the edge of the touch control face S0, the accuracy of pressure detection and position detection may be further improved.

Illustratively, in FIG. 4, the haptic feedback module includes two pressure-sensitive detectors 12 which are both second pressure-sensitive detectors 122, and the orthographic projections of the two second pressure-sensitive detectors 122 on the touch control face S0 are respectively disposed close to different edges. Further, the orthographic projections of the two second pressure-sensitive detectors 122 on the touch control face S0 are respectively disposed close to opposite edges, the second pressure-sensitive detector 122 on the left side is close to a left edge of the touch control face S0, and the second pressure-sensitive detector 122 on the right side is close to a right edge of the touch control face S0.

In some embodiments, as shown in any one of FIG. 1, and FIG. 5 to FIG. 10, the shape of the touch control face S0 is a polygonal shape (such as the rectangular shown in the drawing), and the above at least one pressure-sensitive detector 12 includes a third pressure-sensitive detector 123, and an orthographic projection of the third pressure-sensitive detector 123 on the touch control face S0 is disposed close to an interior angle of the polygonal shape.

During specific implementation, the haptic feedback module may include one or more third pressure-sensitive detectors 123. By disposing a plurality of third pressure-sensitive detectors 123 in the haptic feedback module, and disposing the plurality of third pressure-sensitive detectors 123 close to the interior angle of the polygonal touch control face S0, the accuracy of pressure detection and position detection may be further improved.

Illustratively, as shown in FIG. 1, FIG. 6 and FIG. 8, the haptic feedback module includes four pressure-sensitive detectors 12 which are all third pressure-sensitive detectors 123, and the orthographic projections of the four third pressure-sensitive detectors 123 on the touch control face S0 are respectively disposed close to different interior angles; and as shown in FIG. 5, FIG. 7 and FIG. 9, the haptic feedback module includes three pressure-sensitive detectors 12 which are all third pressure-sensitive detectors 123, and the orthographic projections of the three third pressure-sensitive detectors 123 on the touch control face S0 are respectively disposed close to different interior angles.

Illustratively, in FIG. 10, the haptic feedback module includes eight pressure-sensitive detectors 12 which include four third pressure-sensitive detectors 123 and four second pressure-sensitive detectors 122, among them, the orthographic projections of the four third pressure-sensitive detectors 123 on the touch control face S0 are respectively disposed close to different interior angles, two second pressure-sensitive detectors 122 of the four second pressure-sensitive detectors 122 are disposed close to the left edge of the touch control face S0, and the other two second pressure-sensitive detectors 122 of the four second pressure-sensitive detectors 122 are disposed close to the right edge of the touch control face S0.

In some embodiments, as shown in FIG. 10, the haptic feedback module includes a plurality of pressure-sensitive detectors 12, wherein the plurality of pressure-sensitive detectors 12 include a first detector group 101 and a second detector group 102, and an orthographic projection of the first detector group 101 on the touch control face S0 and an orthographic projection of the second detector group 102 on the touch control face S0 are respectively disposed close to different edges of the touch control face S0. Further, the orthographic projection of the first detector group 101 on the touch control face S0 and the orthographic projection of the second detector group 102 on the touch control face S0 are respectively disposed close to opposite edges of the touch control face S0.

Illustratively, in FIG. 10, four pressure-sensitive detectors 12 in the first detector group 101 are disposed close to the left edge of the touch control face S0, and the four pressure-sensitive detectors 12 in the first detector group 101 are arranged along the left edge of the touch control face S0; and four pressure-sensitive detectors 12 in the second detector group 102 are disposed close to the right edge of the touch control face S0, and the four pressure-sensitive detectors 12 in the second detector group 102 are arranged along the right edge of the touch control face S0.

In some embodiments, as shown in any one of FIG. 1, FIG. 4, FIG. 6, FIG. 8 and FIG. 10, the haptic feedback module includes a plurality of pressure-sensitive detectors 12, wherein the orthographic projections of the plurality of pressure-sensitive detectors 12 on the touch control face S0 are symmetrically disposed with respect to the geometric center O of the touch control face S0.

Illustratively, as shown in FIG. 4, the haptic feedback module includes two pressure-sensitive detectors 12, wherein the orthographic projections of the two pressure-sensitive detectors 12 on the touch control face S0 are symmetrical with respect to the geometric center O of the touch control face S0; as shown in FIG. 1, FIG. 6 and FIG. 8, the haptic feedback module includes four pressure-sensitive detectors 12, wherein the orthographic projections of the four pressure-sensitive detectors 12 on the touch control face S0 are symmetrical with respect to the geometric center O of the touch control face S0; and as shown in FIG. 10, the haptic feedback module includes eight pressure-sensitive detectors 12, wherein the orthographic projections of the eight pressure-sensitive detectors 12 on the touch control face S0 are symmetrical with respect to the geometric center O of the touch control face S0.

In some embodiments, the haptic feedback module further includes: a module outer bezel 14 including a bottom plate 141, wherein the bottom plate 141 is located on one side of the touch control module 11 facing away from the touch control face S0.

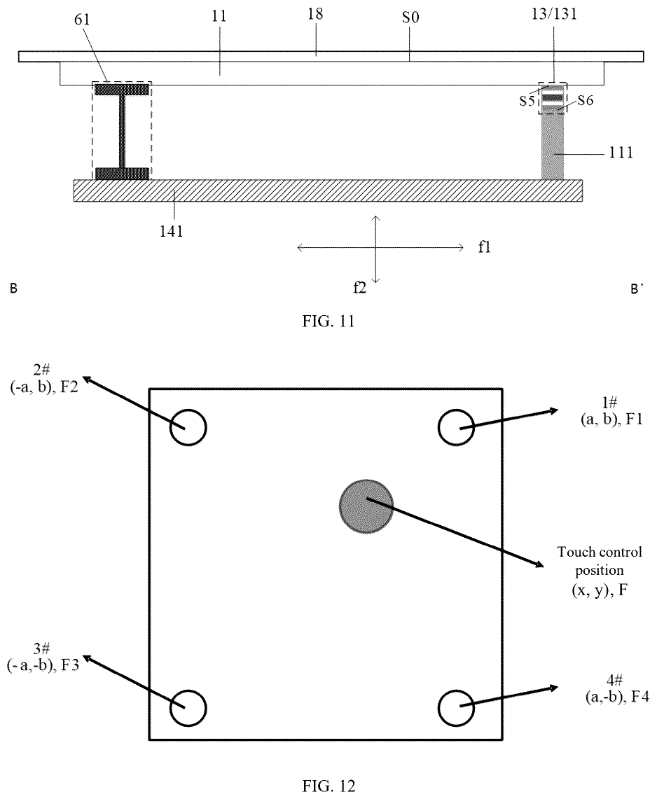

Illustratively, an orthographic projection of the bottom plate 141 on the touch control face S0 may cover the orthographic projection of the touch control module 11 on the touch control face S0 (as shown in FIG. 2), and the orthographic projection of the bottom plate 141 on the touch control face S0 may also be located within a range of the orthographic projection of the touch control module 11 on the touch control face S0 (as shown in FIG. 11).

Illustratively, as shown in FIG. 2, the module outer bezel 14 may further include a side plate 142, the side plate 142 is located on one side of the bottom plate 141 and connected to an edge of the bottom plate 141, and an accommodating space and a window are formed by the enclosure of the bottom plate 141 and the side plate 142, wherein the touch control module 11 is disposed in the accommodating space, and the touch control face S0 faces the window.

In some embodiments, the pressure-sensitive detector 12 is located on one side of the touch control module 11 close to the bottom plate 141, namely, the pressure-sensitive detector 12 is located between the touch control module 11 and the bottom plate 141 in the accommodating space. Illustratively, as shown in FIG. 2, the pressure-sensitive detector 12 is located on a surface of one side of the touch control module 11 close to the bottom plate 141.

In some embodiments, as shown in FIG. 2, the pressure-sensitive detector 12 includes a first surface S1 and a second surface S2 which are disposed opposite to each other, wherein the first surface S1 is connected to the touch control module 11, and the second surface S2 is located on one side of the first surface S1 away from the touch control module 11. The haptic feedback module further includes: at least one cantilever beam including a first cantilever beam 15, wherein one end of the first cantilever beam 15 (an upper end of the first cantilever beam 15 as shown in FIG. 2) is connected to the second surface S2, and the other end thereof (a lower end of the first cantilever beam 15 as shown in FIG. 2) is connected to the bottom plate 141.

In this way, by disposing the first cantilever beam 15 to be connected to the bottom plate 141, the first cantilever beam 15 also has the function of supporting the spacing between the touch control module 11 and the bottom plate 141, thereby being beneficial to improving the consistency of the spacing between the touch control module 11 and the bottom plate 141 at different positions.

Among them, the first surface S1 and the second surface S2 are disposed opposite to each other in a normal direction f2 of the touch control face S0. In FIG. 2, an upper surface of the pressure-sensitive detector 12 is the first surface S1, and a lower surface of the pressure-sensitive detector 12 is the second surface S2.

In some embodiments, as shown in FIG. 5, FIG. 7 or FIG. 9, the above at least one cantilever beam may further include: a second cantilever beam 61. As shown in FIG. 11, one end of the second cantilever beam 61 (an upper end of the second cantilever beam 61 as shown in FIG. 11) is connected to the touch control module 11, and the other end of the second cantilever beam 61 (a lower end of the second cantilever beam 61 as shown in FIG. 11) is connected to the bottom plate 141. Moreover, in the normal direction f2 of the touch control face S0, a height of the second cantilever beam 61 is greater than a height of the first cantilever beam 15.

Since the first cantilever beam 15 and the touch control module 11 are provided with the pressure-sensitive detectors 12, and the second cantilever beam 61 and the touch control module 11 are not provided with the pressure-sensitive detectors 12, by setting the height of the second cantilever beam 61 to be greater than the height of the first cantilever beam 15, the consistency of the spacing between the touch control module 11 and the bottom plate 141 at different positions may be improved.

Illustratively, a height difference between the second cantilever beam 61 and the first cantilever beam 15 may be a thickness of the pressure-sensitive detector 12, so that the consistency of the spacing between the touch control module 11 and the bottom plate 141 may be ensured.

In some embodiments, an orthographic projection of the second cantilever beam 61 on the touch control face S0 may be disposed close to the geometric center of the touch control face S0, may also be disposed close to the edge of the touch control face S0, and may also be disposed close to the interior angle of the touch control face S0 in the case where the shape of the touch control face S0 is the polygonal shape, as shown in FIG. 5, FIG. 7 or FIG. 9. In FIG. 5, FIG. 7 and FIG. 9, the orthographic projections of the first cantilever beam 15 and the second cantilever beam 61 on the touch control face S0 are respectively disposed close to different interior angles of the touch control face S0, so that the consistency of the spacing between the touch control module 11 and the bottom plate 141 may be further improved.

In some embodiments, a shape of a longitudinal cross section of the cantilever beam includes at least one of: an H shape, a Z shape, a three-sided box shape, an I shape, an L shape, a T shape, and a rectangular shape, and the longitudinal cross section of the cantilever beam is perpendicular to the touch control face S0.

Illustratively, as shown in FIG. 2, the shape of the longitudinal cross section of the first cantilever beam 15 is the H shape.

In some embodiments, as shown in FIG. 2, the first cantilever beam 15 includes: a first cantilever 21, a first connecting face 22, and a second connecting face 23, wherein the first cantilever 21 is located between the first connecting face 22 and the second connecting face 23, the first connecting face 22 and the second surface S2 are parallel to each other and are connected to each other, the second connecting face 23 and the bottom plate 141 are parallel to each other and are connected to each other, and an extension direction of the first cantilever 21 and a plane where the bottom plate is located intersect with each other. Illustratively, as shown in FIG. 2, the extension direction of the first cantilever 21 and the plane where the bottom plate 141 is located are perpendicular to each other.

In some embodiments, as shown in FIG. 2, in a first direction f1, a width of the first cantilever 21 is less than a width of the first connecting face 22 and the second connecting face 23, and the first direction f1 is a direction parallel to the touch control face S0. In this way, by disposing the relatively narrow first cantilever 21, the first cantilever beam 15 may be prevented from obstructing the horizontal vibration of the touch control module 11, thereby reducing the influence on the horizontal vibration of the touch control module 11.

It should be noted that in the first direction f1, the width of the first cantilever 21 may also be greater than or equal to the width of the first connecting face 22, and the width of the first cantilever 21 may also be greater than or equal to the width of the second connecting face 23.

In some embodiments, various parts of the cantilever beam, such as the first cantilever 21, the first connecting face 22, and the second connecting face 23 of the first cantilever beam 15, may be of an integral structure and of the same material. In this way, the cantilever beam may be integrally molded, thereby simplifying the machining and mounting procedures.

In some embodiments, a material of the cantilever beam may be selected from an aluminum alloy, a titanium alloy, tungsten steel, stainless steels, and the like, which is not limited in the present disclosure.

In some embodiments, a shape of the orthographic projection of the pressure-sensitive detector 12 on the touch control face S0 includes at least one of: regular shapes such as a circular shape, an elliptical shape, a polygonal shape, a fan shape, and an annular shape, and an irregular pattern.

Illustratively, as shown in any one of FIG. 1, and FIG. 3 to FIG. 5, the orthographic projection of the pressure-sensitive detector 12 on the touch control face S0 is square; as shown in FIG. 6 or FIG. 7, the orthographic projection of the pressure-sensitive detector 12 on the touch control face S0 is circular; and as shown in FIG. 8 or FIG. 9, the orthographic projection of the pressure-sensitive detector 12 on the touch control face S0 is annular.

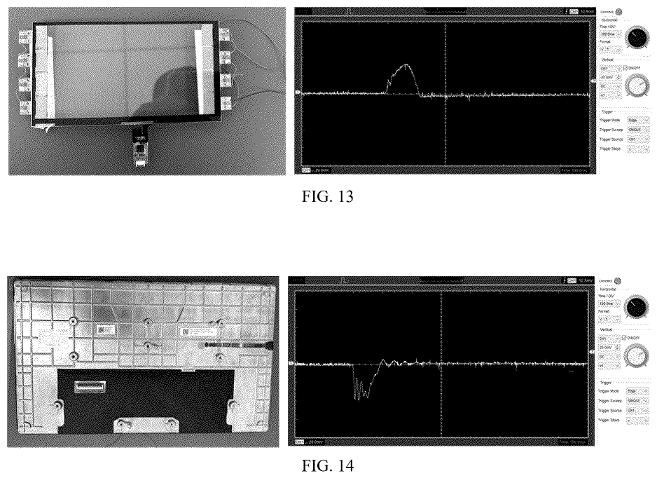

Referring to the left diagram in FIG. 13, an exemplary diagram of a 6.95-inch touch control module 11 bonded with eight pressure-sensitive detectors 12 is shown, with four pressure-sensitive detectors 12 on the left side and the right side, and the pressure-sensitive detector 12 includes a plurality of layers of piezoelectric ceramic patches, such as TDK PiezoHapt-L PHUA3015-30A-21-000. Two terminals of the pressure-sensitive detector 12 at a lower right corner are connected to an oscilloscope, and an output signal of the pressure-sensitive detector 12 at the lower right corner is measured in the case where the finger presses the touch control module 11.

When a pressing force is about 80 gf, the output signal is as shown in the right diagram of FIG. 13, and an electrical signal of about 32.8 mV is output. Then, a vehicle-mounted central control module having a mass of 1,376 g is placed on the touch control module 11 shown in FIG. 13, and as shown in the left diagram of FIG. 14, the output signal of the pressure-sensitive detector 12 at the lower right corner is measured in the case where the finger presses the vehicle-mounted central control module. When the pressing force is about 80 gf, the output signal is as shown in the right diagram of FIG. 14, and an electrical signal of about 40 mV is output. According to test results, it can be found that the pressure-sensitive detector 12 may be used for detecting pressure information, and in a large-size and large-mass touch control feedback module, the pressure-sensitive detector 12 can still measure a relatively accurate result.

During specific implementation, the actuator 13 may be located on one side of the touch control module 11 close to the touch control face S0, for example, in a bezel area of the touch control face S0; and the actuator 13 may also be located on a side face of the touch control module 11. In these two cases, the width of the bezel of the haptic feedback module is increased, thereby being not conducive to achieving a narrow bezel.

In some embodiments, as shown in FIG. 2, the actuator 13 is located between the touch control module 11 and the bottom plate 141 in the accommodating space.

In some embodiments, as shown in FIG. 2, the actuator 13 includes a third surface S3 and a fourth surface S4 which are disposed opposite to each other along the first direction f1, wherein the first direction f1 is parallel to the touch control face S0; the haptic feedback module further includes: a first supporting portion 16 connected between the third surface S3 and the touch control module 11; and a second supporting portion 17 connected between the fourth surface S4 and the bottom plate 141.

In this embodiment, a vibration direction of the actuator 13 may be parallel to the touch control face S0 or perpendicular to the touch control face S0, which is not limited in the present disclosure.

Illustratively, the touch control face S0 includes a long side and a short side, and the vibration direction of the actuator 13 may be parallel to the long side, or parallel to the short side, or form an included angle of an acute angle with the long side, which is not limited in the present disclosure.

Among them, the first supporting portion 16 has the functions of fixedly supporting the touch control module 11 and conducting the vibration of the actuator 13 to the touch control module 11; and the second supporting portion 17 has the function of fixedly supporting the actuator 13 to the bottom plate 141.

In some embodiments, the first supporting portion 16 is in rigid connection with the third surface S3, and the first supporting portion 16 is in rigid connection with the touch control module 11, thereby ensuring that the actuator 13 can drive the touch control module 11 to vibrate together without causing too much vibration attenuation at a connecting position.

In some embodiments, the second supporting portion 17 is in flexible or rigid connection with the bottom plate 141. By flexibly connecting the second supporting portion 17 to the bottom plate 141, excited vibration of the bottom plate 141 may be avoided.

Among them, the second supporting portion 17 may be in rigid connection or flexible connection with the fourth surface S4, which is not limited in the present disclosure.

Since the touch control module 11 for vehicle-mounted display has the features of large size, high rigidity and large mass, in order to improve the mechanical stability of the haptic feedback module for vehicle-mounted display, the second supporting portion 17 may be connected to the bottom plate 141 by adopting a rigid connecting mode, such as a screw.

As shown in FIG. 2 or FIG. 11, the haptic feedback module further includes a cover plate 18, wherein the cover plate 18 is located on the touch control module 11 and one side of the module outer bezel 14 close to the touch control face S0, and has the functions of encapsulating and protecting the touch control module 11, and wherein flexible connection may also be adopted between the cover plate 18 and the module outer bezel 14 to prevent vibration from being conducted to the module outer bezel 14 through the cover plate 18.

Illustratively, for the rigid connection, bonding may be performed by a hard adhesive, for example, a rigid adhesive such as an epoxy adhesive, connection may also be performed by a welding mode, and connection may also be performed by the screw.

Illustratively, for the flexible connection, bonding may be performed by adopting a soft adhesive, for example, a flexible adhesive tape such as a double-sided adhesive tape, and a very high bond (VHB) adhesive tape (a polyacrylate double-sided foam tape), or may also be performed by adopting a liquid adhesive such as polyurethane glue, which is not limited in the present disclosure.

In some embodiments, as shown in FIG. 2, the first supporting portion 16 includes a first supporting face 161 and a second supporting face 162 which are cross-connected to each other, wherein the first supporting face 161 is parallel to the touch control face S0, the second supporting face 162 is located on one side of the first supporting face 161 away from the touch control module 11, the first supporting face 161 is connected to the touch control module 11, and the second supporting face 162 is connected to the third surface S3.

Illustratively, in FIG. 2, the first supporting face 161 and the second supporting face 162 are perpendicular to each other. The first supporting face 161 and the second supporting face 162 may be of an integral structure and of the same material. In this way, the first supporting portion 16 may be integrally molded, thereby simplifying the machining and mounting procedures.

In some embodiments, as shown in FIG. 2, the second supporting portion 17 includes a third supporting face 171 and a fourth supporting face 172 which are cross-connected to each other, wherein the third supporting face 171 and the bottom plate 141 are parallel to each other, the fourth supporting face 172 is located on one side of the third supporting face 171 away from the bottom plate 141, the third supporting face 171 is connected to the bottom plate 141, and the fourth supporting face 172 is connected to the fourth surface S4.

Illustratively, in FIG. 2, the third supporting face 171 and the fourth supporting face 172 are perpendicular to each other. The third supporting face 171 and the fourth supporting face 172 may be of an integral structure and of the same material. In this way, the second supporting portion 17 may be integrally molded, thereby simplifying the machining and mounting procedures.

In some embodiments, as shown in FIG. 2, the entire third surface S3 is connected to the second supporting face 162, thereby ensuring that the vibration of the actuator 13 is conducted to the touch control module 11 almost without attenuation, and reducing the attenuation of the vibration at the connecting position.

In order to ensure that there is no direct contact between the actuator 13 and the touch control module 11, in some embodiments, as shown in FIG. 2, in the normal direction f2 of the touch control face S0, a size of the second supporting face 162 is greater than a size of the actuator 13.

In order to ensure that there is no direct contact between the actuator 13 and the bottom plate 141, in some embodiments, as shown in FIG. 2, in the normal direction f2 of the touch control face S0, a size of the fourth supporting face 172 is greater than the size of the actuator 13.

Further, as shown in FIG. 2, in the normal direction f2 of the touch control face S0, the actuator 13 is connected to a part of the second supporting face 162 away from the touch control module 11; and in the normal direction f2 of the touch control face S0, the actuator 13 is connected to a part of the fourth supporting face 172 close to the touch control module 11.

In some embodiments, as shown in FIG. 1, in the first direction f1, the actuator 13 is connected to a middle area of the first supporting portion 16, the actuator 13 is connected to a middle area of the second supporting portion 17, and an edge area of the first supporting portion 16 is connected to an edge area of the second supporting portion 17 by a rigid connector 19, wherein the rigid connector 19 is substantially parallel to the touch control face S0.

In this way, the vibration generated by the touch control module 11 driven by the actuator 13 in the normal direction of the touch control face S0 may be weakened, thereby being conducive to enhancing the vibration generated by the touch control module 11 driven by the actuator 13 in the direction parallel to the touch control face S0.

In an embodiment, one or more rigid connectors 19 may be disposed in the haptic feedback module for connecting the edge area of the first supporting portion 16 to the edge area of the second supporting portion 17. Illustratively, in FIG. 1, two rigid connectors 19 are disposed in the haptic feedback module, and the two rigid connectors 19 are located on two sides of the actuator 13. In this way, the vibration generated by the touch control module 11 driven by the actuator 13 in the normal direction of the touch control face S0 may be further weakened, and the vibration generated by the touch control module 11 driven by the actuator 13 in the direction parallel to the touch control face S0 may be further enhanced.

Illustratively, as shown in FIG. 1, the rigid connector 19 may include, for example, a screw and a nut, wherein the screw sequentially passes through through-holes in the second supporting portion 17 and the first supporting portion 16 so as to be connected to the nut.

During specific implementation, as shown in FIG. 2, the screw hole in the second supporting portion 17 may be located in the fourth supporting face 172, and the through-hole in the first supporting portion 16 may be located in the second supporting face 162, which is not limited in the present disclosure.

In order to prevent the rigid connector 19 from influencing the vibration of the touch control module 11 in the horizontal direction (namely, the first direction f1), an elastic gasket 110 may be disposed between the rigid connector 19 and the first supporting portion 16. Among them, the elastic gasket 110 is made of a material capable of generating elastic deformation, such as a rubber ring. Illustratively, as shown in FIG. 1, the elastic gasket 110 is disposed on the screw in a penetrating way and located between the first supporting portion 16 and the nut.

In some embodiments, a modulus of elasticity of the first supporting portion 16 is greater than or equal to 10 GPa, and less than or equal to 300 GPa, such as tens of GPa. The material of the first supporting portion 16 may be selected from an aluminum alloy, a titanium alloy, tungsten steel, stainless steel, and the like, which is not limited in the present disclosure.

In some embodiments, a modulus of elasticity of the second supporting portion 17 is greater than or equal to 10 GPa, and less than or equal to 300 GPa, such as tens of GPa. The material of the second supporting portion 17 may be selected from an aluminum alloy, a titanium alloy, tungsten steel, stainless steel, and the like, which is not limited in the present disclosure.

In some embodiments, the materials of the first supporting portion 16 and the second supporting portion 17 may be the same or different.

In some embodiments, a shape of a longitudinal cross section of the first supporting portion 16 includes at least one of: an H shape, a Z shape, a three-sided box shape, an I shape, an L shape, a T shape, and a rectangular shape, and the longitudinal cross section of the first supporting portion 16 is perpendicular to the touch control face S0.

In some embodiments, a shape of a longitudinal cross section of the second supporting portion 17 includes at least one of: an H shape, a Z shape, a three-sided box shape, an I shape, an L shape, a T shape, and a rectangular shape, and the longitudinal cross section of the second supporting portion 17 is perpendicular to the touch control face S0.

Illustratively, in FIG. 2, the shapes of the longitudinal cross sections of both the first supporting portion 16 and the second supporting portion 17 are L shapes.

It should be noted that the second supporting portion 17 may be connected not only to the bottom plate 141 but also to the side plate 142, and may be connected to both the bottom plate 141 and the side plate 142, which is not limited in the present disclosure. By disposing the second supporting portion 17 to be connected to the bottom plate 141, compared with being connected to the side plate 142, the second supporting portion 17 also has the function of supporting the spacing between the touch control module 11 and the bottom plate 141, thereby being conducive to improving the consistency of the spacing between the touch control module 11 and the bottom plate 141 at different positions.

In some embodiments, as shown in FIG. 11, the actuator 13 includes a fifth surface S5 and a sixth surface S6 which are disposed opposite to each other along a second direction f2, wherein the second direction f2 is perpendicular to the touch control face S0, the fifth surface S5 is connected to the touch control module 11, the sixth surface S6 is located on one side of the fifth surface S5 away from the touch control module 11, and the haptic feedback module further includes: a third supporting portion 111 connected between the sixth surface S6 and the bottom plate 141.

In this embodiment, the vibration direction of the actuator 13 may be perpendicular to the touch control face S0 and may also be parallel to the touch control face S0, which is not limited in the present disclosure.

Among them, the third supporting portion 111 has the function of fixedly supporting the actuator 13 to the bottom plate 141.

In order to reduce the attenuation of the vibration at the connecting position, the fifth surface S5 is in rigid connection with the touch control module 11. The third supporting portion 111 may be in flexible or rigid connection with the bottom plate 141. By flexibly connecting the third supporting portion 111 to the bottom plate 141, excited vibration of the bottom plate 141 may be avoided. The third supporting portion 111 may be in rigid connection or flexible connection with the sixth surface S6.

It should be noted that the third supporting portion 111 may be connected not only to the bottom plate 141 but also to the side plate 142, and may be connected to both the bottom plate 141 and the side plate 142, which is not limited in the present disclosure. By disposing the third supporting portion 111 to be connected to the bottom plate 141, compared with being connected to the side plate 142, the third supporting portion 111 also has the function of supporting the spacing between the touch control module 11 and the bottom plate 141, thereby being conducive to improving the consistency of the spacing between the touch control module 11 and the bottom plate 141 at different positions.

In order to achieve a narrow bezel, in some embodiments, as shown in FIG. 2, the actuator 13 and the pressure-sensitive detector 12 are located on the same side of the touch control module 11.

As shown in FIG. 2, the actuator 13 and the pressure-sensitive detector 12 are both located on one side of the touch control module 11 facing away from the touch control face S0, thereby not only being conducive to achieving the narrow bezel, but also being conducive to reducing the thickness of the haptic feedback module.

In some embodiments, as shown in FIG. 4 or FIG. 10, the orthographic projection of the actuator 13 on the touch control face S0 is disposed close to the geometric center O of the touch control face S0.

In some embodiments, as shown in any one of FIG. 1, FIG. 3, and FIG. 5 to FIG. 9, the orthographic projection of the actuator 13 on the touch control face S0 is disposed close to the edge of the touch control face S0.

During specific implementation, in the case where the shape of the touch control face S0 is the polygonal shape, the orthographic projection of the actuator 13 on the touch control face S0 may also be disposed close to the interior angle of the polygonal shape, which is not limited in the present disclosure.

In some embodiments, the actuator 13 includes at least one of: a lead zirconate titanate (PZT) piezoelectric thin film, monolithic piezoelectric ceramic, stacked piezoelectric ceramic, cymbal-shaped piezoelectric ceramic (as shown in FIG. 1 to FIG. 11), a monolithic polyvinylidene fluoride film, a stacked polyvinylidene fluoride film, and a cymbal-shaped polyvinylidene fluoride film.

Illustratively, the actuator 13 is a device operating by utilizing an inverse piezoelectric effect of the piezoelectric material. An inverse effect of the “positive piezoelectric effect”, namely, the elastic deformation of a dielectric medium driven by the electrical signal, is called the “inverse piezoelectric effect”. Compared with a monolithic structure, the actuators 13 of a stacked structure and a cymbal-shaped structure have the features of low-voltage driving, stronger vibration sense and larger displacement, and are more suitable for achieving the haptic feedback effect on large-size and heavy-mass haptic feedback modules.

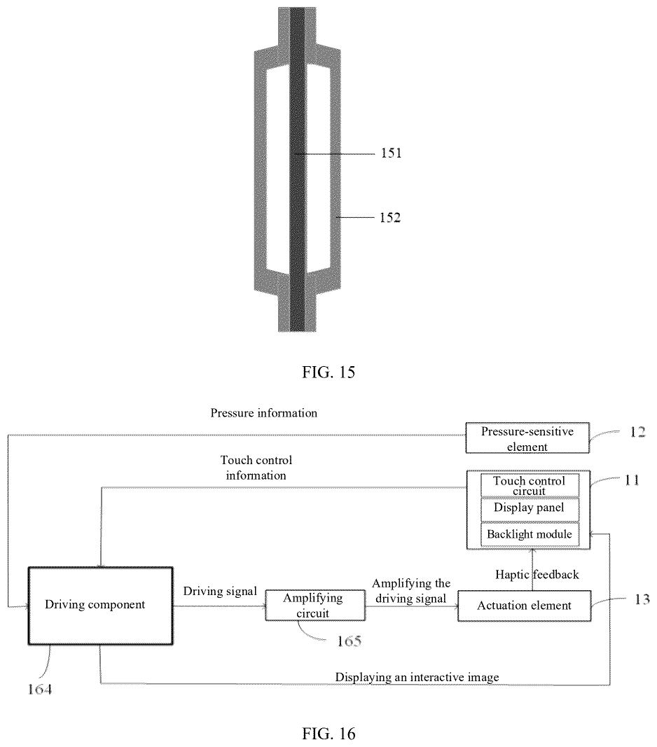

Referring to FIG. 15, an actuator 13 of a cymbal-shaped piezoelectric ceramic structure is shown, including a piezoelectric ceramic patch 151 located at a middle position, and hinge structures 152 disposed on two sides of the piezoelectric ceramic patch 151, wherein the hinge structures 152 are connected to an edge of the piezoelectric ceramic patch 151, and gaps are formed between a middle area of the piezoelectric ceramic patch 151 and the hinge structures 152. Among them, surfaces of the hinge structures 152 facing away from the piezoelectric ceramic patch 151 are the third surface S3, the fourth surface S4, the fifth surface S5 or the sixth surface S6, and may be connected to the first supporting portion 16, the second supporting portion 17, the third supporting portion 111 or the touch control module 11.

In some embodiments, the distance between the touch control module 11 and the bottom plate 141 is the same at the position of the pressure-sensitive detector 12 and at the position of the actuator 13.

The present disclosure further provides a haptic feedback apparatus. Referring to FIG. 16, the haptic feedback apparatus includes: the haptic feedback module provided in any one of the embodiments, wherein the touch control module 11 includes at least one of: a touch control circuit, a display panel, and a backlight module; and a driving component 164 respectively connected to the touch control module 11, the pressure-sensitive detector 12, and the actuator 13, and used for driving the display panel to display an image, and outputting a driving signal to the actuator 13 according to touch control information of a touch control body on the touch control module 11 and pressure information of the touch control body on the touch control module 11 detected by the pressure-sensitive detector 12, so that the actuator 13 drives the touch control module 11 to vibrate in response to the driving signal, so as to form the haptic feedback on the touch control face S0, wherein the touch control information includes at least one of: a touch control position, a touch control time, and a touch control action.

It will be understood by those skilled in the art that the haptic feedback apparatus provided in the present disclosure has the advantages of the above haptic feedback module. The haptic feedback apparatus provided in the present disclosure may be integrated in products such as notebooks, and displays, and may be used as a display screen in numerous fields such as vehicle-mounted display, and consumer electronics to provide a user with rich and realistic haptic experience.

As shown in FIG. 16, the driving component 164 controls to display an interactive image on the display panel. When the touch control body performs touch control operation on the touch control module 11, the touch control information may be detected by the touch control module 11 or the pressure-sensitive detector 12, the pressure information may be detected by the pressure-sensitive detector 12, the driving component 164 generates the driving signal according to the detected touch control information and pressure information, and the driving signal is used for driving the actuator 13 to drive the touch control module 11 to generate vibration, so as to generate the haptic feedback effect on the surface of the touch control module 11.

Among them, the touch control action may be, for example, an operation gesture of the finger, such as clicking, sliding, and a sliding track.

It should be noted that the touch control circuit may be integrated inside the display panel, and may also be disposed separately from the display panel, for example, attached to a light-emitting side of the display panel, which is not limited in the present disclosure.

In some embodiments, the display panel may be a liquid crystal display panel or a self-luminous display panel, which is not limited in the present disclosure. Among them, the self-luminous display panel has a light-emitting device built therein, and the light-emitting device may be, for example, an Organic Light-Emitting Diode (OLED), a Quantum Dot Light-Emitting Diode (QLED), a Mini Light-Emitting Diode (Mini LED) or a Micro Light-Emitting Diode (Micro LED), and the like.

Among them, the touch control position may be obtained according to a detection result of the pressure-sensitive detector 12, and may also be obtained according to a detection result of the touch control circuit in the touch control module 11, which is not limited in the present disclosure.

In order to enable the touch control module 11 to detect the touch control position, and the like, in some embodiments, the touch control module 11 may include a capacitive touch control circuit or a resistive touch control circuit, which is not limited in the present disclosure.

With regard to the capacitive touch control circuit, when the touch control body, such as the finger of the user, touches the touch control module 11, touch control capacitance of a touch control driving electrode and a touch control sensing electrode in the touch control circuit at the touch control position changes, touch control wiring in the touch control circuit may send the touch control capacitance at each position to the driving component 164, and the driving component 164 may determine the touch control position according to the touch control capacitance at each position.

In some embodiments, the driving component 164 may include a controller and a driver. Illustratively, when the touch control body applies the touch control operation to the touch control module 11, the controller outputs a driving signal in the form of a digital signal to the driver according to the touch control information detected by the touch control module 11 and the pressure information detected by the pressure-sensitive detector 12 in response to the touch control operation, the driver generates a driving signal in the form of an analogue signal after performing digital-to-analogue conversion on the driving signal in the form of the digital signal, and sends the driving signal to the actuator 13, and the actuator 13 vibrates under the driving of the driving signal so as to drive the touch control module 11 to vibrate, and then form the haptic feedback.

Illustratively, the controller may include, for example, at least one of: a Microcontroller Unit (MCU), a Field Programmable Gata Array (FPGA), and the like, which is not limited in this example.

Illustratively, when the haptic feedback apparatus is applied in a terminal, the driving component 164 may be a processor in the terminal.

In some embodiments, as shown in FIG. 16, the haptic feedback apparatus may further include: an amplifying circuit 165 respectively connected to the driving component 164 and the actuator 13, and used for amplifying the driving signal output by the driving component 164 and sending the amplified signal to the actuator 13.

Illustratively, as shown in FIG. 2, the haptic feedback apparatus may further include a cover plate 18, such as reinforced glass, disposed on the touch control module 11 for protecting the touch control module 11 and the actuator 13.

In the present disclosure, the meaning of “plurality of” refers to two or more, and the meaning of “at least one” refers to one or more, unless otherwise specified.

In the present disclosure, the terms “up”, “down”, etc. indicate orientation or positional relationships based on the orientation or positional relationships shown in the accompanying drawings, only for the convenience of describing the present disclosure and simplifying the description, and do not indicate or imply that the device or component referred to must have a specific orientation, be constructed and operated in a specific orientation, and therefore cannot be understood as a limitation of the present disclosure.

In the specification, the terms “including/comprising”, “containing”, or any other variation thereof are intended to encompass non-exclusive inclusion, such that a process, method, product, or equipment that includes a series of elements includes not only those elements, but also other elements not explicitly listed, or elements inherent to such process, method, product, or equipment. Without further limitations, the element defined by the statement “including one . . . ” does not exclude the existence of other identical elements in the process, method, product, or device that includes the element in question.

The terms “one embodiment”, “some embodiments”, “exemplary embodiments”, “one or more embodiments”, “examples”, “one example”, “some examples”, etc. referred to in the specification are intended to indicate that specific features, structures, materials, or characteristics related to the embodiment or example are included in at least one embodiment or example disclosed herein. The schematic representation of the above terms does not necessarily refer to the same embodiment or example. In addition, the specific features, structures, materials, or characteristics described may be included in any appropriate manner in any one or more embodiments or examples.

In the specification, relational terms such as first and second are only used to distinguish one entity or operation from another, and do not necessarily require or imply any actual relationship or order between these entities or operations.

When describing some embodiments, expressions such as “coupling” and “connection” may be used. For example, in describing some embodiments, the term “connection” may be used to indicate that two or more components have direct physical or electrical contact with each other. For example, in describing some embodiments, the term “coupling” may be used to indicate that two or more components have direct physical or electrical contact. However, the term “coupled” or “communicably coupled” may also refer to two or more components that do not have direct contact with each other but still cooperate or interact with each other. The embodiments disclosed here are not necessarily limited to the content of the specification.

“At least one of A, B, and C” has the same meaning as “at least one of A, B, or C” and includes the following combinations of A, B, and C: only A, only B, only C, a combination of A and B, a combination of A and C, a combination of B and C, and a combination of A, B, and C.

“A and/or B” includes the following three combinations: only A, only B, and a combination of A and B.

As used in the specification, the term “if” is optionally interpreted as meaning “when” or “at” or “in response to a determination” or “in response to a detection” depending on the context. Similarly, depending on the context, the phrases “if determined . . . ” or “if [stated condition or event] is detected” may be interpreted as referring to “when determined . . . ” or “in response to determining . . . ” or “when [stated condition or event] is detected” or “in response to detecting [stated condition or event]”.

The use of “used for” or “configured as” in the specification implies an open and inclusive language, which does not exclude devices that are applicable or configured to perform additional tasks or steps.

The use of “based on” or “according to” in the specification implies openness and inclusiveness. A process, step, calculation, or other action based on one or more of the conditions or values described, which may be based on other conditions or beyond the values described in practice. The process, steps, calculations, or other actions based on one or more of the stated conditions or values may, in practice, be based on other conditions or beyond the stated values.

As used in the specification, “about”, “roughly”, or “approximately” include the values described and the average value within an acceptable deviation range of a specific value, where the acceptable deviation range is determined by persons skilled in the art taking into account the measurement being discussed and the errors associated with the measurement of a specific quantity (i.e., limitations of the measurement system).

As used in the specification, “parallel”, “vertical”, “equal”, and “flush” include the situations described and situations that are similar to the described situations, and the range of the similar situations is within an acceptable deviation range, where the acceptable deviation range is determined by persons skilled in the art considering the measurement being discussed and the errors associated with the measurement of a specific quantity (i.e., the limitations of the measurement system). For example, “parallel” includes absolute parallelism and approximate parallelism, where the acceptable deviation range for approximate parallelism may be within 5° of deviation; “vertical” includes absolute vertical and approximate vertical, where the acceptable deviation range for approximate vertical may also be within 5° of deviation, for example. “Equal” includes absolute equality and approximate equality, where the acceptable deviation range for approximate equality may be, for example, that the difference between the equal two is less than or equal to 5% of either one. “Flush” includes absolute flush and approximate flush, where the acceptable deviation range for approximate flush may be, for example, that the distance between the flush two is less than or equal to 5% of either dimension.

It should be understood that when a layer or component is referred to as being on another layer or substrate, it may be directly on another layer or substrate, or there may be an intermediate layer between the layer or component and another layer or substrate.

The specification describes exemplary implementations with reference to sectional diagram and/or plane diagram as idealized illustrative figures. In the attached figures, the thickness of the layers and areas has been enlarged for clarity. Therefore, it may be assumed that there may be changes in the shape relative to the drawings due to factors such as manufacturing technology and/or tolerances. Therefore, the exemplary implementations should not be interpreted as limited to the shapes of the areas shown in the specification, but rather include shape deviations caused by, for example, manufacturing. For example, etched areas shown as rectangles typically have curved features. Therefore, the areas shown in the figures are essentially illustrative, and their shapes are not intended to show the actual shape of the area of the device, nor are they intended to limit the scope of the exemplary implementations.

Finally, it should be noted that the above embodiments are only used to illustrate the technical solution of the present disclosure and not to limit it. Although the present disclosure has been described in detail with reference to the aforementioned embodiments, those skilled in the art should understand that they may still modify the technical solutions described in the aforementioned embodiments, or equivalently replace some of the technical features. And these modifications or substitutions do not depart from the essence and scope of the corresponding technical solutions disclosed in the present disclosure.

1. A haptic feedback module, comprising:
a touch control module having a touch control face;
at least one pressure-sensitive detector disposed on one side of the touch control module facing away from the touch control face, and used for detecting pressure information of a touch control body on the touch control face; and
at least one actuator disposed on at least one side of the touch control module, and used for driving the touch control module to generate vibration in response to a driving signal, so as to form haptic feedback on the touch control face.

2. The haptic feedback module according to claim 1, wherein the at least one pressure-sensitive detector comprises at least one of:
a first pressure-sensitive detector, wherein an orthographic projection of the first pressure-sensitive detector on the touch control face is disposed close to a geometric center of the touch control face;
a second pressure-sensitive detector, wherein an orthographic projection of the second pressure-sensitive detector on the touch control face is disposed close to an edge of the touch control face; and
a third pressure-sensitive detector, wherein a shape of the touch control face is a polygonal shape, and an orthographic projection of the third pressure-sensitive detector on the touch control face is disposed close to an interior angle of the polygonal shape.

3. The haptic feedback module according to claim 1, comprising a plurality of pressure-sensitive detectors, wherein the plurality of pressure-sensitive detectors comprise a first detector group and a second detector group, and an orthographic projection of the first detector group on the touch control face and an orthographic projection of the second detector group on the touch control face are respectively disposed close to opposite edges of the touch control face.

4. The haptic feedback module according to claim 1, comprising a plurality of pressure-sensitive detectors, wherein an orthographic projection of the plurality of pressure-sensitive detectors on the touch control face are symmetrically disposed with respect to a geometric center of the touch control face.

5. The haptic feedback module according to claim 1, further comprising:
a module outer bezel comprising a bottom plate, wherein the bottom plate is located on one side of the touch control module facing away from the touch control face.

6. The haptic feedback module according to claim 5, wherein the pressure-sensitive detector is located on one side of the touch control module close to the bottom plate;
wherein the pressure-sensitive detector comprises a first surface and a second surface which are disposed opposite to each other, the first surface is connected to the touch control module, the second surface is located on one side of the first surface away from the touch control module, and the haptic feedback module further comprises:
at least one cantilever beam comprising a first cantilever beam, wherein one end of the first cantilever beam is connected to the second surface and the other end of the first cantilever beam is connected to the bottom plate.

7. (canceled)

8. The haptic feedback module according to claim 6, wherein the at least one cantilever beam further comprises:
a second cantilever beam, wherein one end of the second cantilever beam is connected to the touch control module and the other end of the second cantilever beam is connected to the bottom plate; and
wherein in a normal direction of the touch control face, a height of the second cantilever beam is greater than a height of the first cantilever beam.

9. The haptic feedback module according to claim 6, wherein a shape of a longitudinal cross section of the cantilever beam comprises at least one of: an H shape, a Z shape, a three-sided box shape, an I shape, an L shape, a T shape, and a rectangular shape, and the longitudinal cross section of the cantilever beam is perpendicular to the touch control face.

10. The haptic feedback module according to claim 6, wherein the first cantilever beam comprises: a first cantilever, a first connecting face, and a second connecting face; the first cantilever is located between the first connecting face and the second connecting face, the first connecting face and the second surface are parallel to each other and are connected to each other, the second connecting face and the bottom plate are parallel to each other and are connected to each other, and an extension direction of the first cantilever and a plane where the bottom plate is located intersect with each other.

11. The haptic feedback module according to claim 10, wherein in a first direction, a width of the first cantilever is less than a width of the first connecting face and the second connecting face, and the first direction is a direction parallel to the touch control face.

12. The haptic feedback module according to claim 1, wherein a shape of an orthographic projection of the pressure-sensitive detector on the touch control face comprises at least one of: a circular shape, an elliptical shape, a polygonal shape, a fan shape, an annular shape, and an irregular pattern.

13. The haptic feedback module according to claim 5, wherein the actuator is located between the touch control module and the bottom plate;
wherein the actuator comprises a third surface and a fourth surface which are disposed opposite to each other along the first direction, and the first direction is parallel to the touch control face; and
the haptic feedback module further comprises:
a first supporting portion connected between the third surface and the touch control module; and
a second supporting portion connected between the fourth surface and the bottom plate.

14. (canceled)

15. The haptic feedback module according to claim 13, wherein the first supporting portion is in rigid connection with the third surface, and the first supporting portion is in rigid connection with the touch control module; and
the second supporting portion is in flexible or rigid connection with the bottom plate.

16. The haptic feedback module according to claim 13, wherein the first supporting portion comprises a first supporting face and a second supporting face which are cross-connected to each other, the first supporting face is parallel to the touch control face, the second supporting face is located on one side of the first supporting face away from the touch control module, the first supporting face is connected to the touch control module, and the second supporting face is connected to the third surface.

17. The haptic feedback module according to claim 16, wherein the second supporting portion comprises a third supporting face and a fourth supporting face which are cross-connected to each other, the third supporting face is parallel to the bottom plate, the fourth supporting face is located on one side of the third supporting face away from the bottom plate, the third supporting face is connected to the bottom plate, and the fourth supporting face is connected to the fourth surface.

18. The haptic feedback module according to claim 17, wherein the entire third surface is connected to the second supporting face;
wherein in a normal direction of the touch control face, a size of the second supporting face is greater than a size of the actuator, and a size of the fourth supporting face is greater than the size of the actuator.

19. (canceled)

20. The haptic feedback module according to claim 18, wherein in the normal direction of the touch control face, the actuator is connected to a part of the second supporting face away from the touch control module, and the actuator is connected to a part of the fourth supporting face close to the touch control module.

21. The haptic feedback module according to claim 13, wherein in the first direction, the actuator is connected to a middle area of the first supporting portion, the actuator is connected to a middle area of the second supporting portion, and an edge area of the first supporting portion is connected to an edge area of the second supporting portion through a rigid connector.

22. The haptic feedback module according to claim 13, wherein a shape of a longitudinal cross section of the first supporting portion comprises at least one of: an H shape, a Z shape, a three-sided box shape, an I shape, an L shape, a T shape, and a rectangular shape, and the longitudinal cross section of the first supporting portion is perpendicular to the touch control face; and/or
a shape of a longitudinal cross section of the second supporting portion comprises at least one of: the H shape, the Z shape, the three-sided box shape, the I shape, the L shape, the T shape, and the rectangular shape, and the longitudinal cross section of the second supporting portion is perpendicular to the touch control face.

23. (canceled)

24. (canceled)

25. (canceled)

26. (canceled)

27. (canceled)

28. (canceled)

29. A haptic feedback apparatus, comprising:
the haptic feedback module according to claim 1, wherein the touch control module comprises at least one of: a touch control circuit, a display panel, and a backlight module; and
a driving component respectively connected to the touch control module, the pressure-sensitive detector, and the actuator, and used for driving the display panel to display an image, and outputting a driving signal to the actuator according to touch control information of a touch control body on the touch control module, and pressure information of the touch control body on the touch control module detected by the pressure-sensitive detector, so that the actuator drives the touch control module to vibrate in response to the driving signal, so as to form the haptic feedback on the touch control face, wherein the touch control information comprises at least one of: a touch control position, a touch control time, and a touch control action.
